(19) United States
(12) Patent Application Publication
(10) Pub. No.: US 2005/0116835 A1
(43) Pub. Date: Jun. 2, 2005

(54) Remote control device for an actuator

(76) Inventor: Bernard Grehant, Annecy (FR)

Correspondence Address: WELSH & KATZ, LTD, 120 S RIVERSIDE PLAZA, 22ND FLOOR, CHICAGO, IL, 60606, US

(21) Appl. No.: 10/508,912

(22) PCT Filed: Mar. 21, 2003
(86) PCT No.: PCT/IB03/01106

(30) Foreign Application Priority Data
Mar. 28, 2002 (FR) 02/03892

(51) Int. Cl. G05B 19/02

(52) U.S. Cl. 340/825.22; 340/825.72; 340/506

(57) ABSTRACT

The device for the remote control of an actuator and/or a sensor of a security and/or comfort and/or monitoring installation for a building, includes a processing unit and a command transmitter. Further included is a transfer means to transfer to the processing unit, from the command transmitter, a processing program relating to the operation of the actuator and/or of the sensor, the program being provided and stored in directly executable form. This device makes it possible to update the operation of the actuator easily.

### FIELD OF THE INVENTION

The invention relates to the field of the wireless remote control of actuators intended for the security or the comfort in buildings, and particularly when the command receiver module intended to control said actuators is not easy to access.

### BACKGROUND OF THE INVENTION

Such actuators are for example motors intended to operate solar protections or closures of the building. The command receiver modules are, depending on the case, directly integrated in the motors or housed in box sections above glazed openings, or are housed in false ceilings in the vicinity of the actuators.

These command receiver modules are commonly of the radiofrequency type and are in fact of the two-way type (radio transceiver) which makes it possible for example to acknowledge reception of received commands and their correct execution.

The invention also relates to the sensors associated with the control system of the aforementioned actuators. These sensors are of the type detecting intrusion, movement, smoke, temperature or are of the meteorological type (wind, sun, etc.), or even of the monitoring type. They have in common the fact of generally being poorly accessible and of also transmitting their information by wireless communication means.

Both the sensors and the actuators are capable of communication with each other and with remote command transmitters of the mobile or fixed type. This communication is therefore carried out without wires, in particular by radio frequency links and complying with a common protocol.

The problem encountered with these devices relates to the plurality of uses which can be made of them at a given state of the art on the one hand and, on the other hand, the evolution of these uses with the evolution of technologies.

This plurality makes it necessary, for the manufacturer, to create many actuator and sensor references and therefore transforms into a plurality of products that which should simply be a plurality of functions. This results in a high cost without corresponding benefit for the user. Thus, for example, an installed electronic motor has different functional characteristics depending on whether it drives a blind or a rolling shutter. It is commonly a matter of two different products whereas nothing fundamentally distinguishes them from one another.

The evolution of technologies, and in particular with regard to transmission protocol and security of information, furthermore has a tendency to make the different generations of products incompatible and also to increase their cost. The difficulty of access to said products also makes any improvement or updating intervention problematic, such intervention or “upgrading” being common in other fields. In fact, methods [symbol] cation and recording in a computing machine of the type commonly called a “PC”, the operating system itself being loaded or downloaded. The field of communication over the Internet has scaled down applications of this kind.

U.S. Pat. No. 5,321,840 gives an example where even the programmable logic array (PLA) of a PC can be reconfigured remotely. A FLASH type EPROM memory is used for storing the reconfiguration code. An anti-virus program and/or new functions can thus be installed remotely.

U.S. Pat. No. 5,210,854 describes a mode of storing updates of software versions in an EEPROM reprogrammable electronic memory, in a data processing system. In this patent, a single reprogrammable electronic memory is used in replacement of a ROM, EEPROM association, but a control logic unit makes it possible to produce a partition of this EEPROM between protected areas containing the non-erasable parts of software and unprotected areas. This partition is itself fixed or is dynamically reconfigurable.

Remaining in the field of remote modification of executable software, the U.S. Pat. No. 6,141,795 proposes a technique minimizing the transfer memory necessary and giving robustness in the event of interruption of the program transfer. This patent is in particular lodged in the field of remote maintenance systems.

In the same way, the U.S. Pat. No. 5,787,288 describes a method of replacing an old program with a new one by previously taking the necessary verification precautions. It is a matter of a remote maintenance application for fax machines accessible by the telephone line.

The manufacturers have of course thought of applying such configuration methods in the field of the remote control of domestic applications, in particular of assemblies of television sets and video recorders, by taking advantage of the flexibility of a PC. This is the case of the device described U.S. Pat. No. 5,774,063, in which the PC is substituted for the infrared remote control unit and therefore allows the equipment to be programmed at will. It is also the same objective of flexibility that is found in the U.S. Pat. No. 5,414,761 according to which it is a matter of reprogramming at will an infrared remote control unit of the “universal” type.

In the field closest to that of the invention, devices are found making it possible to communicate data to a Heating, Ventilating and Air Conditioning (HVAC) device. In the European patent EP 0 652 502, there is described the insertion of one or more smart cards into the reader of a control device (programmer-thermostat). The card contains “programming data” which can also be entered by the user by means of a keyboard. This operation is long and tedious insofar as it is necessary to enter command temperatures, time periods and possibly other parameters. These programming data are transferable from the card into the resident memory unit, or vice-versa, which makes it possible to retain in a card programming entered on the keyboard. It will be noted that this is a matter of transferring a “heating program”, consisting in fact of data (command temperature, area concerned, time, day of the week, etc.) and not of an “executable program” in the data processing meaning, intended for the direct control of the microprocessor contained in the equipment.

In the same Heating, Ventilating and Air Conditioning field, in the U.S. Pat. No. 5,156,203, there is provided a remote identification of the occupant of a premises (by smart card and/or radio transponder). All of the data relating to the comfort situation of the occupant are stored, in such a way as to reproduce the same data when the same person again enters the premises. There is therefore learning and switchover from one set of data to another according to the users, by means of a resident program, and there is no modification of that resident program. This functioning in the building has something in common with the automatic adjustment of seats and rear-view mirrors in a motor vehicle as soon as the driver is recognized by means of his key.

In the same field as that described in the invention, that of actuators and/or sensors intended for security or comfort in a building, there are found systems for the radio transmission of authorized identifiers, in particular in the American patent U.S. Pat. No. 4,750,118, systems for setting to a mode of learning identifiers by means of the radio transmission normally used for the transmission of commands, in particular in the European patent EP 1 031 953, or systems for the remote learning of ends of travel of the motor or for the remote implementation of a program to reverse the direction of rotation, such as for example in the European patent EP 0 493 322, or, finally, for parameter setting by means of the sector of an actuator normally controlled by radio, such as divulged by the patent application FR 2 826 521. However, it has never been conceived to transmit, by means of the radio communication link normally used between a command transmitter, even of a special type, and an actuator, or between a command transmitter and a sensor, or between an actuator and a sensor, one or more programs executable directly by the microprocessors contained in said products.

From the application EP 0 770 965, there is known a universal remote control unit whose operating program can be updated by transmission from the controlled apparatuses to the remote control unit.

However, it has never been conceived to improve the existing functionalities of actuators or of sensors by replacing all or part of their executable programs.

Moreover, it has even less been conceived to confer onto actuators or sensors new functionalities, not installed at the time of their initial installation.

The control device according to the invention is characterized by the characterizing part of claim 1.

This device makes it possible to improve, on site, the existing functionalities of the equipment of the building. It furthermore makes it possible to confer on the equipment new functionalities that were not installed in this equipment at the time of its installation.

### BRIEF DESCRIPTION OF THE INVENTION

Other features and advantages of the invention will emerge from the following description given with reference to the appended drawings which are given only as non-limiting examples.

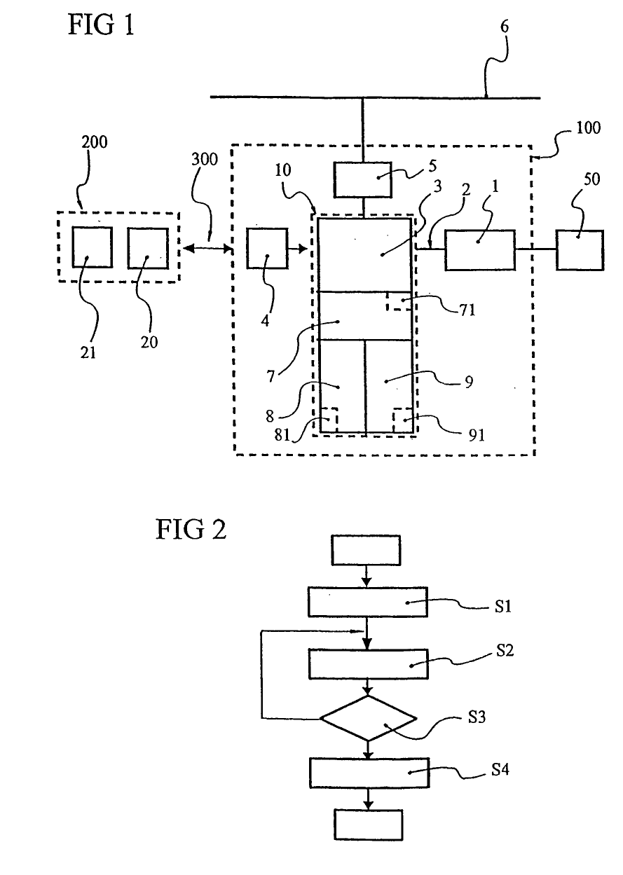

FIG. 1 is a diagrammatic representation of the hardware configuration necessary for the implementation of the invention; and

FIG. 2 shows the method applicable to the invention in the form of a flowchart.

### DETAILED DESCRIPTION

In FIG. 1 there is shown an actuator (1) which is for example an electric motor, intended to actuate a mobile element (50), such as for example a door, a rolling shutter, a blind or any other solar protection. This actuator (1) is for example electrically connected by a wired link (2) to a processing unit (10).

This processing unit (10), containing at least one microprocessor (3), is in relationship with a radio frequency communication means such as a two-way radio transmitter (4). This radio transmitter (4) is therefore able to communicate in reception and in transmission with any radiofrequency device sharing the same transmission protocol.

The processing unit (10) executes the programs contained in a defined non erasable program memory (7) and, depending on the forms of embodiment, in at least a first reprogrammable memory (8) and/or a second reprogrammable memory (9), as explained below.

The actuator (1) is a motor for driving doors, ventilation openings, rolling shutters, blinds or various solar protection screens. It can also be a lighting or alarm device to which access is difficult. The radio transmitter (4) therefore has an essentially receiving function in normal operation.

One or more sensors can be associated with the actuator. A simple sensor can also take the place of the actuator in the following description. In this case, the information essentially passes from the sensor to the processing unit (10) and the radio transmitter (4) then has an essentially transmitting function in normal operation.

The link (2) between the actuator (1) and the processing unit (10) is simply a wired link.

In FIG. 1, which is diagrammatic, the electromagnetic or static contactors making it possible to provide power to the actuator in response to commands from the processing unit have not been shown as all of these devices are well known to those skilled in the art.

If it is a matter of a non-autonomous actuator (1), such as shown in FIG. 1, the assembly is powered with a converter (5) from the alternating current mains (6).

In the case where the actuator (1) is autonomous or is a simple sensor, the converter (5) and the alternating current mains (6) are replaced by an autonomous source, for example a photovoltaic panel and a converter with a battery.

As seen previously, the processing unit (10) comprises a microprocessor (3). It can also be any type of microcontroller, in which case the memory (7) can be integrated in the microcontroller. The radio transmitter (4) can contain its own microcontroller for managing the communication protocol, but this function can be provided by the processing unit (10) or it can be divided between both units, that is to say between said processing unit (10) and the transmitter (4).

It should be noted that the processing unit (10), the actuator (1), the converter (5) and the transmitter (4) can constitute a single hardware assembly that will be called a communication, processing and actuation unit (100).

A command transmitter (200) is provided, which is used in the same communication network, symbolized by the two-way arrow (300). This command transmitter (200) consists of a two-way transmitter (20), similar to the radio transmitter (4) of the communication, processing and actuation unit (100), and a control unit (21) whose functioning will be described hereafter. The command transmitter (200) contains an executable program to be transferred.

The memory (7) contains the program part and the data that will not in any circumstances be modified during the service life of the product. It is a matter of the program providing the basic functions related to the interface with the communication module (4) and related to the operation of the first reprogrammable memory (8) and/or the second reprogrammable memory (9). This memory (7) is therefore of the ROM type and its content is defined by the manufacturer of the processing unit (10). The memory (7) contains, in particular, a storage area (71) making it possible to store at least one code relating to the type of hardware installed in the processing unit (10).

The first reprogrammable memory (8) is of the EEPROM type and is therefore electrically erasable. In present day technology, it will be an EEPROM of the FLASH type. This memory contains, in particular, a storage area (81) making it possible to store at least one code relating to the application.

The second reprogrammable memory (9) is either of the RAM type, or is also of the EEPROM type, depending on the types of embodiment explained below.

FIG. 2 is a view in the form of a flowchart, intended to explain in a simplified manner the entry of new functionalities in the actuator control and/or sensor equipment.

In a first step (S1), the communication, processing and actuation unit (100) receives from the command transmitter (200) a request to be put into learning mode in order to update the executable program.

It must be noted that several equivalent communication, processing and actuation units (100) can, according to the invention, receive the same request. This request is transmitted by the command transmitter (200) by including in the transmission frame a special code for putting into learning mode and, preferably, at least one of the following two items of information:
the hardware configuration code, such as placed in the storage area (71) of the memory (7),
the application code, such as placed in the storage area (81) of the memory (8).

Advantageously, the two items of information will be addressed in the transmission frame coming from the command transmitter (200). Therefore, in this way, during a collective process of updating application programs within the same building, there is therefore, due to the means of the invention, the possibility of addressing the instruction to put into learning mode only to those products involved with the entry of this new version.

In a variant of the invention, the command transmitter (200) is also made to transmit a “common key” code known in the form of a group name by all of the products constituting the home automation system. This thereby avoids having to simultaneously modify the executable programs in products not belonging to the system.

In the first step, represented by (S1), the communication, processing and actuation unit (100) receiving the request to go into the mode for learning an executable program therefore advantageously verifies that it is involved, by verification of the hardware configuration code, such as stored in the storage area (71) of the memory (7), and/or of the application code, such as stored in the storage area (81) of the memory (8), and possibly by verification of being included in a group name or a common address broadcast by the command transmitter (200). According to one feature of the invention, only the receivers complying with these criteria carry out the method illustrated in FIG. 2.

In the second step, represented by (S2), the command transmitter (200) transmits a program executable by the processing unit (10). This program is received by the processing unit (10) and stored in random access memory (RAM, 9) by the microprocessor (3) under the control of a program in the memory (7).

In the third step, which is represented by (S3), the microprocessor (3) checks that the transmission and storage of the program have been completed. This test is of course accompanied by a test of the validity of the binary values received and recorded, using known error detection, or even error correcting tests (CRC, etc.)

The invention takes advantage of the two-way nature of the communication between the command transmitter (200) and the communication, processing and actuation unit (100) in order that parts that are incorrectly received because of interference are repeated.

Only the elements of the communication, processing and actuation unit (100) having passed all the validity tests move on to the next step.

In the fourth step (S4), there is a transfer of the transmitted program from the random access memory (RAM, 9) to the read only memory (EEPROM, 8). Depending on the case, this program relates to all of the functions, or simply to a few specific functions, but the whole thing therefore constitutes an update of the application. The application code, such as stored in the storage area (81) of the memory (8) of the new application forms part of the transmission and will therefore be updated in all of the modified products.

This fourth step (S4) can be completed by an acknowledgement of radio reception or by the transmission of a signal by the products excluded during the second step (S2) or the third step (S3) in order that the installer can possibly restart the whole procedure for these products.

Once the procedure is completed, all of the products involved are therefore provided with functionalities that they did not have at the time of the installation, or certain existing functionalities have been improved.

It must be noted that variants of the modification procedure are possible, as is known to those skilled in the art. Thus, it can be decided to give the second reprogrammable memory (9) the same EEPROM structure as the first reprogramable memory (8) by also providing in it a storage area (91) for the application code. If this decision is made, it will be decided that only the first memory (8) or the second memory (9) shall contain the active application at a given time. If, like before, it is the first memory (8), then the instructions of the new program will be stored in the second memory (9) during the second step (S2) and vice-versa. After the consistency test, the fourth step (S4) becomes simply a switchover command: the active program memory becomes the second memory (9), and the first memory (8) will possibly be used for storing a new program during a subsequent updating.

The principle of the invention applies equally well to the functionalities that are part of the operation of the actuators and/or of the sensors of the home automation system as to the various processings relating to the transmission over the communication network, in the context of the control products of the said home automation actuators and/or sensors.

Furthermore, it is clear that the binary words constituting the program can be transmitted in a compressed form necessitating a decompression, or they can be encrypted and decrypted, etc.

After these various processings, which are not included in the principle of the invention, the binary words stored in memory will be directly interpreted as programming instructions, called “machine language” or “assembler”, by the microprocessor (3) of the processing unit (10).

With regard to the command transmission unit (200), its form is not an essential feature of the invention. It can be a general control unit, already known in the installation during the preliminary pairing procedures, in which a memory card reader is provided, allowing the owner himself to carry out an update. It can also be a general control unit linked with other communication gateways (Internet, etc.) or a computer equipped with a communication system of the type of the transmitter (20). The control unit (21) contains a sufficient number of control keys to engage the update request procedure, and if possible a screen making it possible to monitor its correct running. This procedure can also be activated in combination with a specific action on the power supply mains, as is known in the prior art.

It may be added that the memory (ROM, 7) and the first memory (EEPROM 8) could be replaced by one and the same memory of the EEPROM type, in which a fixed or dynamic partition is carried out.

The invention is not of course limited to the embodiments described and shown as examples but it also includes all of the equivalent techniques and their combinations.

1-9. (canceled)

10. A device for the remote control of an actuator and/or a sensor for the security and/or comfort and/or monitoring installation of a building, comprising a processing unit, a command transmitter, and a transfer means, the device configured to transfer to the processing unit, from the command transmitter, a processing program relating to the operation of the actuator and/or of the sensor, said processing program stored in directly executable form.

11. The device according to claim 10, wherein the actuator is configured to drive a shading or closure element.

12. The device according to claim 10, wherein the processing unit, a radio transmitter, and the actuator define a communication, processing and actuation unit, said radio transmitter configured to communicate in a reception mode and in a transmission mode with any radio frequency device sharing the same transmission protocol, wherein the communication, processing and actuation unit is configured to receive, store, and execute the processing program.

13. The device according to claim 12, wherein the processing unit comprises a microprocessor which executes one or more programs contained in a program memory having at least one reprogrammable portion.

14. The device according to claim 13, wherein a non-erasable program memory contains a storage area configured to store at least one code segment relating to the type of hardware installed in the processing unit.

15. The device according to claim 14, wherein the reprogrammable memory contains a storage area configured to store at least one code segment relating to an application.

16. The device according to claim 10 wherein the command transmitter contains the executable program to be transferred, and includes a two-way transmitter, a processing and actuation unit, and a control unit, in which the program to be transferred is stored.

17. A method for updating the operation of an actuator and/or a sensor controlled by at least one processing unit and intended for the security and/or the comfort and/or the monitoring of a building, the method comprising:
transmitting binary data by means of radio waves to the actuator and/or to the sensor, the binary data including
at least one code program directly executable by the processing unit of the actuator and/or of the sensor;
at least one product and/or application identification code; and
the program and the identification code being stored in an electrically reprogrammable memory of the processing unit.

18. The method according to claim 17 herein including providing the processing unit with a processing program relating to the operation of the actuator and/or of the sensor, the processing program being provided by a command transmitter and stored in a form directly executable by the processing unit.
